(19) United States
(12) Patent Application Publication
(10) Pub. No.: US 2011/0165550 A1
(43) Pub. Date: Jul. 7, 2011

(54) Management system for online test assessment and method thereof

(75) Inventor: Bong Jin Jang, Seoul (KR)

(73) Assignee: Ubion Corp., Seoul (KR)

(21) Appl. No.: 12/802,430

(22) Filed: Jun. 7, 2010

(30) Foreign Application Priority Data
Jan. 7, 2010 (KR) 10-2010-0001158

(51) Int. Cl. G09B 7/00

(52) U.S. Cl. 434/362

(57) ABSTRACT

The present disclosure relates to an online test assessment management system and method thereof. The system includes a learner-information database to store login information, personal information, and learning level information of a learner; an item pool database to store questions for an online test and outputting the questions on an online test examination screen during the online test; an online test unit to perform the online test through the online test examination screen and to collect data about a sequence of inputting answers by a learner with regard to questions output for the online test, the number of clicks for changing selected answers, and a reaction time taken in inputting a certain answer after a learner selects the certain answer; and a reaction pattern analysis unit to analyze a learner's online test data collected by the online test unit, and to assess, diagnose and electronically report learner's learning level, learning ability and examination behavior to a learner or teacher terminal.

### CROSS-REFERENCE TO RELATED APPLICATIONS

This application claims the benefit and priority of KR 10-2010-0001158, filed Jan. 7, 2010. The entire disclosure of the above application is incorporated herein by reference.

### BACKGROUND

1. Technical Field

The present invention relates to a management system for online test assessment and a method thereof and, more particularly, to a management system for online test assessment and a method thereof, which can efficiently assess a learning level of a learner and diagnose an examination type by recording and analyzing a sequence of selecting answers and a time to solve the answers that a learner inputs with regard to objective questions during an online test assessment.

2. Description of the Related Art

In a conventional learning method, a learning process is generally progressed based on a curriculum, a lecture time, and a classified degree of difficulty for learners in schools, educational institutes, in-house training institutes, etc.

However, such a conventional learning method requires only a passive role of a learner and does not reflect any personal characteristics of the learner, such as an individual learning level, individual learning ability, and the like, in terms of degree of difficulty in a learning process, so that it is not particularly conducive to enhancing the learning level of the learner.

To solve such problems of the conventional method, online learning has been developed, wherein learners gain education by taking time and expense for a lecture on the Internet and a learning result is assessed by a test on a learning site or an educational institute that provides the lecture or by a test authorized by a government.

Such online learning is also a provider-centered learning method similar to the conventional method, and provides standardized lectures regardless of scholastic achievement of learners.

For assessment of a learner who takes an online course, a variety of questions and tests are provided to the learner along with a result diagnosis through a learning management server.

On the other hand, a typical online test carries out an online test assessment with reference to a lecture provided to a learner and determines only whether answers are correct or not without additional explanation with regard to the result of the online test assessment. Thus, it is difficult not only to recognize learner's weaknesses, but also to continue learning management of such weaknesses when learner's volition is excluded.

To overcome this problem, Korean Patent Application No. 2000-27989 discloses a system that enables individual and correct assessment of a learner's learning level and permits a learner to perform a repetitive learning process corresponding to the assessment result, and a customized online learning method based on a combination of lectures that can enhance a learner's learning level via the online learning system and permits a learner to continue strengthening weaknesses of the learner.

The foregoing system and method can detect a question that a learner answers incorrectly during a test, and can generate a customized lecture to allow continuous learning by analyzing weaknesses of the learner through detection of at least one of a class, a chapter and a degree of difficulty with regard to the question corresponding to the incorrect answer, and extracting and combining lectures, questions and explanatory moving pictures in real time. However, the system and method have problems in that it is difficult to perform comprehensive assessment and determination of a learning type, method and ability of solving questions and judgment capability of a learner, and much time and effort are required for continuous learning.

Examples of techniques related to e-learning include a technique for managing questions through establishment of a question database such as an item pool, and a feedback technique that is based on test paper management for assessment of learners, test management practically performed via the Internet, assessment result analysis of a learner, and result reporting.

Further, various assessment solutions are currently employed for assessment of personal ability and learning results for admission to higher grade schools or for promotion, as well as in English areas, such as Internet-Based Test (IBT), Graduate Record Examination (GRE), etc.

However, the conventional system for online test assessment does not suggest a method of assessing a learning level by analyzing a learning level and learning type through analysis of learner's answer input reactions.

### BRIEF SUMMARY

The present invention is directed to solving the problems of the conventional technique as described above, and an aspect of the present invention is to provide a management system and method for online test assessment, wherein a sequence of selecting answers to objective questions, the number of clicks, and a reaction time are all reflected in an assessment result in the online test assessment to assess a learner's ability by analyzing the learner's reaction to an objective question, thereby efficiently assessing and diagnosing the learner's understanding of questions and examination skills.

Further, another aspect of the present invention is to provide a management system and method for online test assessment, which can enhance learner capacity to solve objective questions by analyzing learner's behavior with respect to an objective examination, and can assess examinee's real ability and enhance the examinee's ability to solve the questions through calculation of a partial point based on understanding of a question in addition to an awarded nominal point.

In accordance with an aspect of the present invention, an online test assessment management system includes a learner-information database to store login information, personal information, and examination behavior information of a learner; an item pool database to store questions for an online test and outputting the questions on an online test examination screen during the online test; an online test unit to perform the online test through the online test examination screen and to collect data about a sequence of inputting answers by the learner with regard to questions output for the online test, the number of clicks for changing selected answers, and a reaction time taken to input an answer after selecting the answer; and a reaction pattern analysis unit to analyze the data collected by the online test unit, and to assess, diagnose and electronically report learner's learning level, learning ability and examination behavior to a learner or teacher terminal.

In accordance with another aspect of the present invention, an online test assessment management method includes electronically accessing, by a learner, an online test assessment management system to take an online test; checking and storing data about a sequence of inputting answers by the learner, the number of clicks for changing selected answers, and a reaction time taken to input selected answers with regard to questions output for the online test; and analyzing the data stored for the online test, assessing and diagnosing examination behavior of the learner based on a correct answer ratio relating to the selection and change of the answers, a nominal point and a real point, and electronically reporting the examination behavior to a learner or teacher terminal, the real point being modified by adding a partial point awarded in consideration of the nominal point, the answer selection, the answer change, and the reaction time.

### BRIEF DESCRIPTION OF THE DRAWINGS

FIG. 1 is a block diagram of a management system for online test assessment according to an embodiment of the present invention.

FIG. 2 is a detailed block diagram of a management server for the online test assessment system shown in FIG. 1.

FIG. 3 is a detailed block diagram of an online test unit shown in FIG. 2.

FIG. 4 is a detailed block diagram of a reaction pattern analysis unit shown in FIG. 2.

FIG. 5 is a detailed block diagram of a partial point calculation module shown in FIG. 4.

FIG. 6 is a flowchart of a management method for online test assessment according to an embodiment of the present invention.

FIG. 7 shows an online test according to questions in the management method for online test assessment according to an embodiment of the present invention.

FIG. 8 shows a flowchart of generating, analyzing and reporting a learner's pattern in the management method for online test assessment according to an embodiment of the present invention.

FIG. 9 shows a process of calculating a real point in the management method for online test assessment according to an embodiment of the present invention.

FIG. 10 shows a process of analyzing a correct answer ratio in the management method for online test assessment according to an embodiment of the present invention.

### DETAILED DESCRIPTION

Hereinafter, embodiments of the present invention will be described in detail with reference to the accompanying drawings.

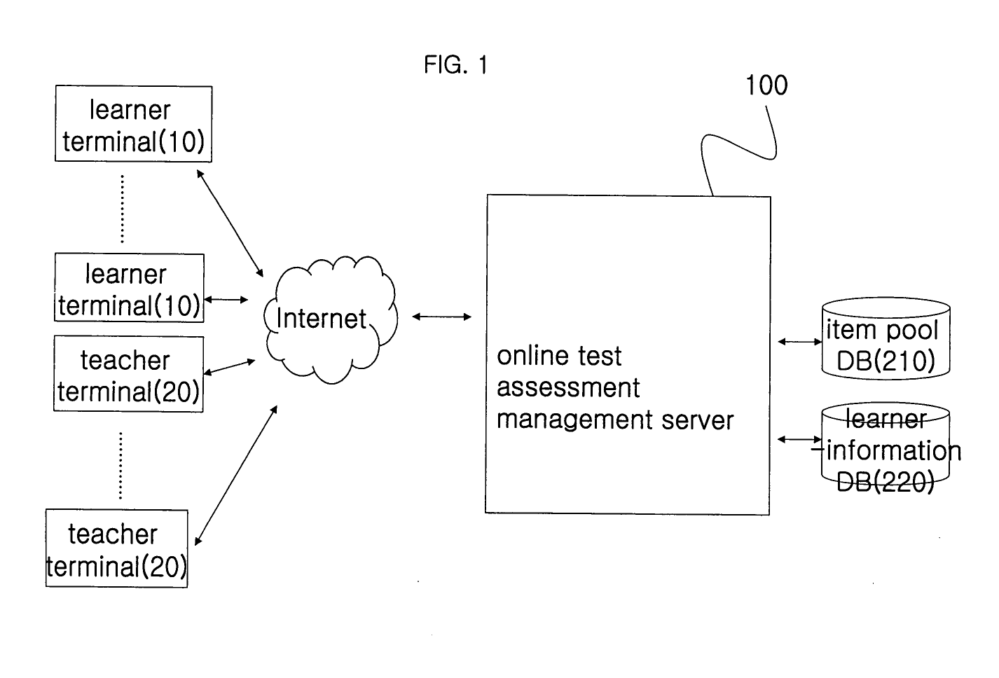

FIG. 1 is a block diagram of a management system for online test assessment according to an embodiment of the present invention.

Referring to FIG. 1, the management system for online test assessment according to an embodiment includes a plurality of learner terminals 10 and teacher terminals 20 capable of supporting an Internet connection, an online test assessment management server 100 which the learner terminal 10 accesses for online testing via the Internet, an item-pool database 210 connected with the online test assessment management server 100, and a learner-information database 220.

The online test assessment management server 100 allows the learner terminal 10 access thereto via the Internet in order to select questions according to sections and levels from the item-pool database 210, to form an examination paper for a certain online test and to electronically output the examination paper to the learner terminal 10 or teacher terminal 20, and feeds back a result and assessment of a learner's response in the online test to the learner terminal 10 or teacher terminal 20.

The learner-information database 220 stores login information, personal information, and examination behavior of a learner.

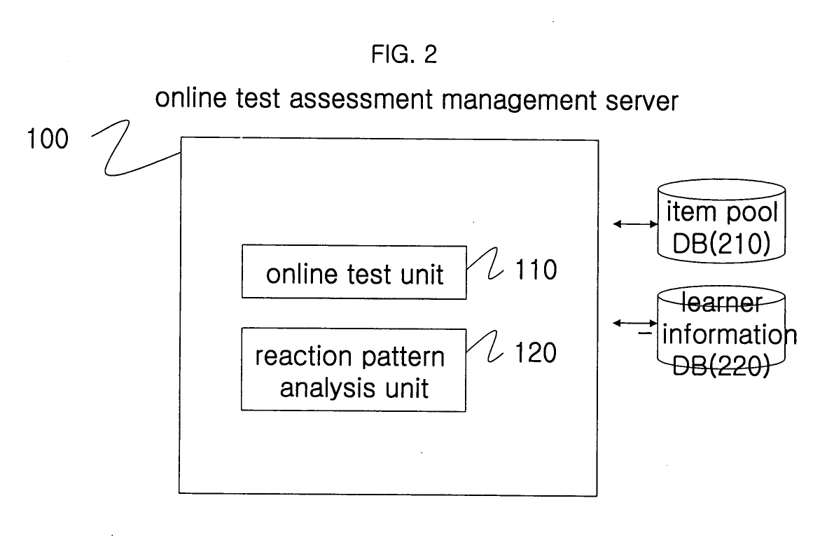

FIG. 2 is a detailed block diagram of a management server for the online test assessment system shown in FIG. 1.

Referring to FIG. 2, the management system for online test assessment of this embodiment includes the item pool database 210, an online test unit 110 connected with the learner-information database 220, and a reaction pattern analysis unit 120.

Here, the management server may employ a teacher information database for storing login information, personal information or the like of a teacher who accesses the online test assessment management server.

The item pool database 210 is a database that stores questions classified according to sections and difficulties in order to extract questions for an online test.

A question type of a certain examination output for an online test may be selected between a true-false type and a multiple choice type. For example, the question type may be a four-answer or five-answer multiple choice type in the form of an objective question.

The online test unit 110 allows a learner to take the online test with questions output through an online test examination screen, and collects data, such as a sequence of inputting answers by a learner with regard to the questions output for the online test, the number of clicks for changing selected answers, and a reaction time taken to input an answer after selecting the answer.

The reaction pattern analysis unit 120 analyzes the data collected by the online test unit 110, assesses and diagnoses the learner's learning level, learning ability and behavior during examination, and then electronically reports the results to the learner terminal 10 or the teacher terminal 20.

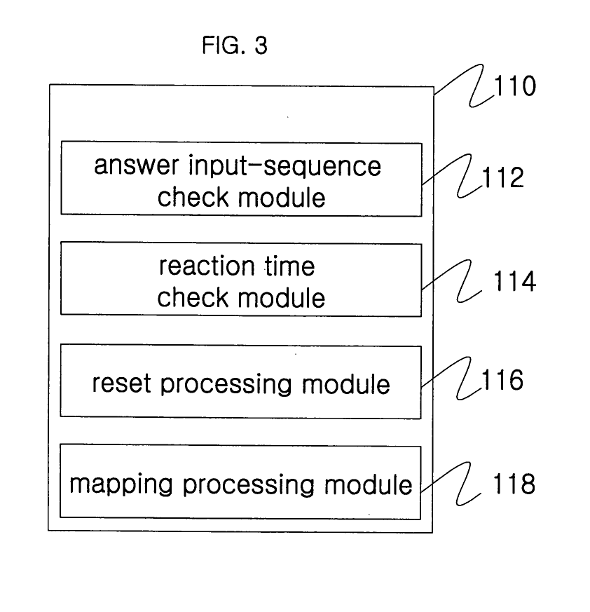

FIG. 3 is a detailed block diagram of an online test unit shown in FIG. 2.

Referring to FIG. 3, the online test unit 110 included in the assessment management server 100 includes an answer input-order check module 112 for checking the sequence with which answers are input and the number of clicks for changing selected answers by a learner with regard to the questions output for the online test.

Further, the online test unit 110 includes a reaction time check module 114 for checking data regarding the reaction time taken to input an answer after a learner selects the answer in the online test.

Further, the online test unit 110 includes a reset processing module 116 for resetting a time limit after one question has been answered and the examination proceeds to the next question in checking the reaction time, and a mapping processing module 118 for mapping and storing the sequence of inputting answers, the reaction time, and the time limit according to the questions.

In this embodiment, the online test unit 110 of the online test assessment management server 100 displays a certain interface on a screen of the learner terminal 10. Here, the selection and change of answers to be processed on a question selecting interface screen, the number of clicks, time limit, and a response input situation of the reaction time are all stored as data for analyzing a learner's reaction as soon as a learner clicks an answer button according to the question type.

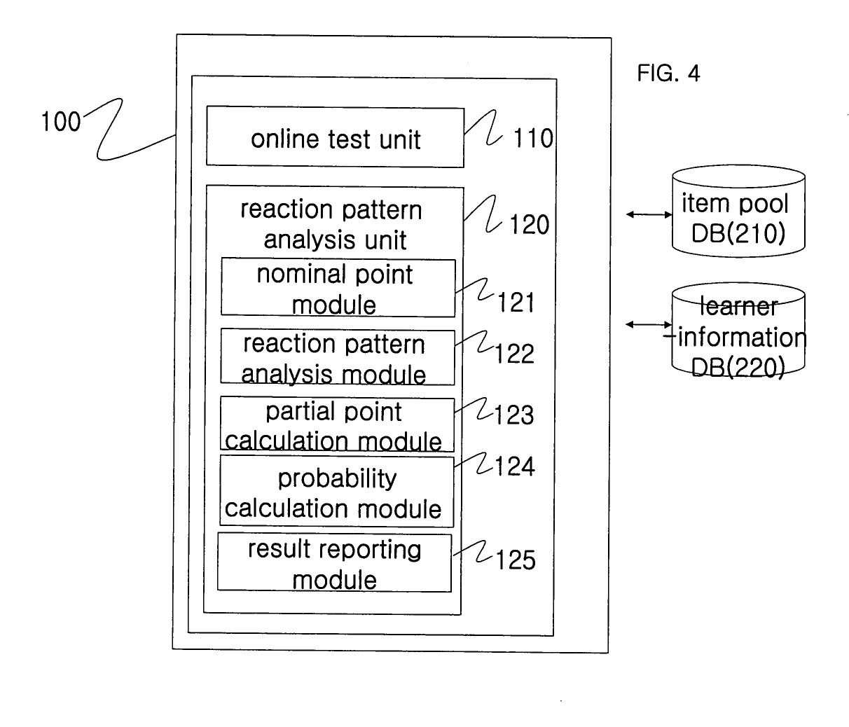

FIG. 4 is a detailed block diagram of a reaction pattern analysis unit shown in FIG. 2.

Referring to FIG. 4, the reaction pattern analysis unit 120 included in the online test assessment management server 100 includes a nominal point module 121, a reaction pattern analysis module 122, a partial point calculation module 123, a probability calculation module 124, and a result reporting module 125.

The nominal point module 121 determines whether an answer selected by a learner is correct or not with respect to a question output for an online test, and affords a nominal point.

The reaction pattern analysis module 122 analyzes data, such as an answer input sequence, the number of clicks for changing selected answers, and a reaction time with respect to questions output for an online test.

By recording the reaction time and the sequence of inputting answers input by a learner, it is possible to efficiently grasp learner's examination skills and to diagnose learner's learning level, thereby feeding back the learner's examination skills.

Further, all of the procedures of selecting answers for the questions are recorded, and thus, when selection of an answer for a certain question is changed, a result of changing the answer is separately recorded and managed. The result of changing the answer is employed as data for analyzing learner's ability, examination skills, and the like.

Further, the record of existing respondent's answer selecting procedures is patterned, and the record of the current learner's answer selecting procedures is compared with the pattern of the existing respondent in order to analyze correlation therebetween.

The partial point calculation module 123 calculates a partial point awarded in consideration of an additional point or a subtractive point resulting from the learner's change of a selected answer, the number of changing times, and the reaction time with respect to the reaction pattern.

The calculation of the partial point is performed by adding a plus partial point based on a point-adding rule when an answer similar to a correct answer is selected.

On the other hand, a minus partial point is added when a leaner selects an answer that does not correspond to the correct answer or is not similar to the correct answer.

If the partial point obtained by summing the plus point and the minus point is a negative value, it will be treated as zero. Further, if a summed point with regard to a certain question is higher than a point allocated to the question, the allocated point will be chosen.

The partial point is not awarded in the case of selecting and inputting an answer within a time less than the minimum time for solving the question.

The probability calculation module 124 calculates a learner's correct answer ratio by input of an answer or input of a corrected answer by changing a selected answer with respect to the reaction pattern.

Here, the probability calculation module 124 compares a correct ratio of the number of correctly guessed questions by answer changing to the total number of questions and an incorrect ratio of the number of incorrectly answered questions by answer changing to the total number of questions with a relative probability of the number of correctly guessed questions without answer changing.

The result reporting module 125 electronically reports a result, which is obtained by analyzing a learner's examination behavior including the correct answer ratio and the partial point according to a learner's answer selection or change based on an assessment result in the reaction pattern, to the learner terminal 10 or the teacher terminal 20.

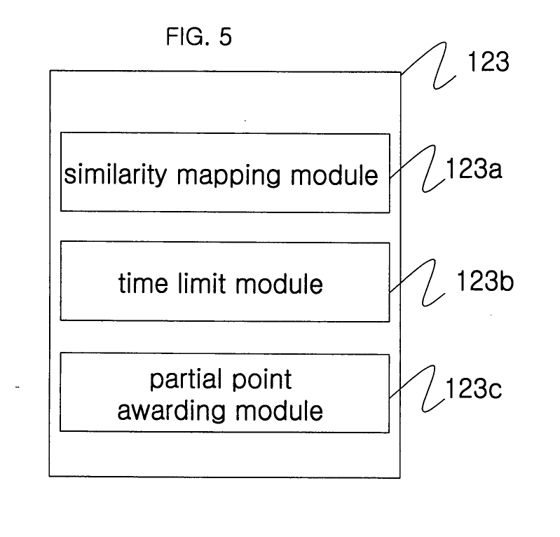

FIG. 5 is a detailed block diagram of a partial point calculation module shown in FIG. 4.

Referring to FIG. 5, the similarity mapping module 123a of the partial point calculation module 123 previously sets a partial point ratio depending on a similarity to a correct answer with respect to an answer input or changed by a learner.

Further, a time limit module 123b sets the partial point ratio by setting the time limit taken for final selection corresponding to learner's input or change of an answer.

Further, a partial point calculation module 123c calculates a plus partial point and a minus partial point to be added to the nominal point based on the partial point ratio estimated by the similarity mapping module and the time limit module.

Table Sheet A shows an embodiment of examinee response data in the online test assessment system according to the invention, Table Sheet B shows an embodiment of detailed examinee analysis information in the online test assessment system according to the invention, and Table Sheet C shows an embodiment of an examinee behavior analysis report in the online test assessment system according to the invention.

Referring to Table Sheet A, data regarding answer selection, answer change, the number of clicks, an input procedure and a reaction time of an examinee ‘Hong Gil-dong’ with respect to questions is collected and stored.

Referring to Table Sheet B, detailed analysis information of the examinee provided by the online test assessment system shows a nominal point obtained when inputting a correct answer to each question, and a modified point awarded in consideration of similarity to the correct answer.

Further, the detailed analysis information shows the number of clicks for changing an answer to each question, an answer-changing procedure, and a reaction time elapsed for selection of each answer.

Table Sheet B shows a result of awarding a plus partial point for a correct answer and a similar answer in accordance with the point-giving rule.

Referring to Table Sheet C, a detailed description of a real point, i.e., a modified point obtained by adding a partial point to a nominal point, and an examination method for enhancing the result based on analysis of an examinee's behavior in selecting answers are provided.

TABLE SHEET A
Hong Gil-dong's information about solution of questions

| | sequence of | sequence of | |
|---|---|---|---|
| Question | selecting | selecting | taken times |
| No. | question | answer | (seconds) |
| 1 | 1 | \textcircled{2} | 108 |
| | | \textcircled{3} | 45 |
| 2 | 2 | \textcircled{1} | 120 |
| | | \textcircled{4} | 30 |
| | | \textcircled{2} | 10 |
| 3 | 3 | \textcircled{2} | 85 |
| | | \textcircled{1} | 61 |
| | | \textcircled{2} | 30 |
| 4 | 16 | \textcircled{1} | 120 |
| 5 | 4 | \textcircled{4} | 95 |
| 6 | 5 | \textcircled{2} | 120 |
| 7 | 6 | \textcircled{3} | 114 |
| 8 | 7 | \textcircled{1} | 123 |
| | | \textcircled{4} | 34 |
| 9 | 8 | \textcircled{1} | 109 |
| 10 | 9 | \textcircled{1} | 132 |
| 11 | 10 | \textcircled{4} | 138 |
| 12 | 17 | \textcircled{4} | 122 |
| | | \textcircled{3} | 100 |
| 13 | 11 | \textcircled{1} | 124 |
| 14 | 12 | \textcircled{2} | 127 |
| 15 | 13 | \textcircled{4} | 134 |
| 16 | 14 | \textcircled{2} | 146 |
| 17 | 15 | \textcircled{2} | 102 |
| | | \textcircled{4} | 60 |
| 18 | 18 | \textcircled{3} | 116 |
| 19 | 19 | \textcircled{3} | 117 |
| 20 | 20 | \textcircled{1} | 125 |
| 21 | 21 | \textcircled{4} | 90 |
| 22 | 22 | \textcircled{2} | 85 |
| 23 | 23 | \textcircled{2} | 68 |
| 24 | 24 | \textcircled{2} | 5 |
| 25 | 25 | \textcircled{2} | 5 |

TABLE SHEET B
Detailed analysis information of Hong Gil-dong

| | seq. | | | | | | | 1st | 2nd | 3rd | 4th | taken |
|---|---|---|---|---|---|---|---|---|---|---|---|---|
| Qtn. | of | cor. | final | | nom. | mod. | ans. sel. | sel. ans | sel. ans. | sel. ans. | sel. ans. | time |
| No. | Qtn. | ans. | sel. ans. | pts. | pts. | pts | time | time(sec) | time(sec) | time(sec) | time(sec) | (sec) |
| 1 | 1 | \textcircled{2} | \textcircled{3} | 4 | 0 | 2 | 2 | \textcircled{2} | \textcircled{3} | | | 153 |
| | | | | | | | | 108 | 45 | | | |
| 2 | 2 | \textcircled{1} | \textcircled{2} | 4 | 0 | 1 | 3 | \textcircled{1} | \textcircled{4} | \textcircled{2} | | 160 |
| | | | | | | | | 120 | 30 | 10 | | |
| 3 | 3 | \textcircled{2} | \textcircled{2} | 4 | 4 | 3 | 3 | \textcircled{2} | \textcircled{1} | \textcircled{2} | | 176 |
| | | | | | | | | 85 | 61 | 30 | | |
| 4 | 16 | \textcircled{1} | \textcircled{1} | 4 | 4 | 4 | 1 | \textcircled{1} | | | | 120 |
| | | | | | | | | 120 | | | | |
| 5 | 4 | \textcircled{4} | \textcircled{4} | 4 | 4 | 4 | 1 | \textcircled{4} | | | | 95 |
| | | | | | | | | 95 | | | | |
| 6 | 5 | \textcircled{3} | \textcircled{2} | 4 | 0 | 0 | 1 | \textcircled{2} | | | | 120 |
| | | | | | | | | 120 | | | | |
| 7 | 6 | \textcircled{3} | \textcircled{3} | 4 | 4 | 4 | 1 | \textcircled{3} | | | | 114 |
| | | | | | | | | 114 | | | | |
| 8 | 7 | \textcircled{1} | \textcircled{4} | 4 | 0 | 0 | 2 | \textcircled{1} | \textcircled{4} | | | 157 |
| | | | | | | | | 123 | 34 | | | |
| 9 | 8 | \textcircled{1} | \textcircled{1} | 4 | 4 | 4 | 1 | \textcircled{1} | | | | 109 |
| | | | | | | | | 109 | | | | |
| 10 | 9 | \textcircled{1} | \textcircled{1} | 4 | 4 | 4 | 1 | \textcircled{1} | | | | 132 |
| | | | | | | | | 132 | | | | |
| 11 | 10 | \textcircled{4} | \textcircled{4} | 4 | 4 | 4 | 1 | \textcircled{4} | | | | 138 |
| | | | | | | | | 138 | | | | |
| 12 | 17 | \textcircled{4} | \textcircled{3} | 4 | 0 | 2 | 2 | \textcircled{4} | \textcircled{3} | | | 222 |
| | | | | | | | | 122 | 100 | | | |
| 13 | 11 | \textcircled{1} | \textcircled{1} | 4 | 4 | 4 | 1 | \textcircled{1} | | | | 124 |
| | | | | | | | | 124 | | | | |
| 14 | 12 | \textcircled{2} | \textcircled{2} | 4 | 4 | 4 | 1 | \textcircled{2} | | | | 127 |
| | | | | | | | | 127 | | | | |
| 15 | 13 | \textcircled{4} | \textcircled{4} | 4 | 4 | 4 | 1 | \textcircled{4} | | | | 134 |
| | | | | | | | | 134 | | | | |
| 16 | 14 | \textcircled{2} | \textcircled{2} | 4 | 4 | 4 | 1 | \textcircled{2} | | | | 146 |
| | | | | | | | | 146 | | | | |
| 17 | 15 | \textcircled{2} | \textcircled{4} | 4 | 0 | 2 | 2 | \textcircled{2} | \textcircled{4} | | | 162 |
| | | | | | | | | 102 | 60 | | | |
| 18 | 18 | \textcircled{3} | \textcircled{3} | 4 | 4 | 4 | 1 | \textcircled{3} | | | | 116 |
| | | | | | | | | 116 | | | | |
| 19 | 19 | \textcircled{3} | \textcircled{3} | 4 | 4 | 4 | 1 | \textcircled{3} | | | | 117 |
| | | | | | | | | 117 | | | | |
| 20 | 20 | \textcircled{1} | \textcircled{1} | 4 | 4 | 4 | 1 | \textcircled{1} | | | | 125 |
| | | | | | | | | 125 | | | | |
| 21 | 21 | \textcircled{4} | \textcircled{4} | 4 | 4 | 4 | 1 | \textcircled{4} | | | | 90 |
| | | | | | | | | 90 | | | | |
| 22 | 22 | \textcircled{1} | \textcircled{2} | 4 | 0 | 0 | 1 | \textcircled{2} | | | | 85 |
| | | | | | | | | 85 | | | | |
| 23 | 23 | \textcircled{2} | \textcircled{2} | 4 | 4 | 4 | 1 | \textcircled{2} | | | | 68 |
| | | | | | | | | 68 | | | | |
| 24 | 24 | \textcircled{2} | \textcircled{2} | 4 | 4 | 0 | 1 | \textcircled{2} | | | | 5 |
| | | | | | | | | 5 | | | | |
| 25 | 25 | \textcircled{4} | \textcircled{2} | 4 | 0 | 0 | 1 | \textcircled{2} | | | | 5 |
| | | | | | | | | 5 | | | | |

TABLE SHEET C
Explanation of question analysis
For Question No. 1, the correct answer is \textcircled{2}, but it was incorrectly changed from \textcircled{2} to \textcircled{3}. However, 2 partial
points (+1 point corresponding to the selection of the correct answer and +1 point corresponding to the selection of
the answer similar to the correct answer) were awarded in practice since the correct answer \textcircled{2} and the answer \textcircled{3}
having a high similarity to the correct answer were selected.
For Question No. 2, the correct answer is \textcircled{1}, but it was incorrectly changed \textcircled{1} −> \textcircled{4} −> \textcircled{2}. However, a partial point
of 1 (+1 point corresponding to the selection of the correct answer, +1 point corresponding to the selection of the
answer similar to the correct answer, and −1 point corresponding to the selection of the answer unrelated to the
correct answer) was awarded in practice because the correct answer \textcircled{1}, the answer \textcircled{2} having a high similarity to
the correct answer, and the answer \textcircled{4} unrelated to the correct answer were selected.
For Question No. 3, the answer \textcircled{2} was correctly guessed, but the answer \textcircled{1} having no similarity to the correct
answer was also selected. Thus, 1 point was deducted in practice.
For Question No. 8, the correct answer is \textcircled{1}, but it was incorrectly changed from \textcircled{1} to \textcircled{4}. However, you were
awarded 0 points since the correct answer \textcircled{1} and the answer \textcircled{4} having no similarity to the correct answer were
selected.
For Question No. 12, the correct answer is \textcircled{4}, but it was incorrectly changed from \textcircled{4} to \textcircled{3}. However, 2 partial
points (+1 point corresponding to the selection of the correct answer and +1 point corresponding to the selection of
the answer similar to the correct answer) were awarded in practice since the correct answer \textcircled{4} and the answer \textcircled{3}
having a high similarity to the correct answer were selected.
For Question No. 17, the correct answer is \textcircled{2}, but it was incorrectly modified \textcircled{2} −> \textcircled{4}. However, 2 partial points (+1
point corresponding to the selection of the correct answer and +1 point corresponding to the selection of the answer
similar to the correct answer) were awarded in practice since the correct answer \textcircled{2} and the answer \textcircled{4} having a
high similarity to the correct answer were selected.
For Question No. 24, even though the answer was correctly guessed, but zero point instead of 4 points was awarded
in practice since it is determined that the question was not normally solved in light of a time of 5 seconds taken in
solving the question.
Abstract information of Hong Gil-doug's point

| Total | | | | answer change | | | | | Nos. of | |
|---|---|---|---|---|---|---|---|---|---|---|
| Nos. of | Nos. of | nom. | real | Nos. of | Nos. of | ratio | Nos. of | ratio | ans. at | exp. pts. |
| Qtn | cor. ans. | pts. | pts. | ch. ans. | cor. ans. | (%) | incor. ans. | (%) | 1st sel. | at 1st sel. |
| 25 | 17 | 68 | 70 | 6 | 1 | 17 | 5 | 83 | 22 | 88 |

Hong Gil-doug's behaviour analysis information
Since 17 questions were correctly guessed among 25 questions, 68 points were awarded. As a result from
calculating a real point through the system analysis, the real point was 70 points.
Among total 6 questions where the answer was changed, the question was correctly guessed once (17%), but the
questions were incorrectly guessed five times (83%)
Very high probability (88%) of the correct answer was achieved at the primary selection. If the primarily selected
answer was not changed. 22 questions were correctly guessed and therefore the nominal 88 points might be
awarded. In the future, you can get a higher score by changing your answer as few times as possible.

The calculation of a partial point is achieved by awarding a plus point based on the point-awarding rule when an answer similar to a correct answer is selected.

For example, in the case where a correct answer of a question No. 1 is \textcircled{2}, if a selected answer is changed from \textcircled{2} to \textcircled{3}, a learner changes from the correct answer to an incorrect answer. Since the answer \textcircled{3} has a high similarity to the correct answer \textcircled{2}, however, it is assessed that a real point of 2 is awarded because 2 points (+1 point corresponding to the selection of the correct answer and +1 point corresponding to the selection of the answer similar to the correct answer) are awarded as a plus partial point although the nominal point is zero.

On the other hand, for a question No. 3, since the answer \textcircled{2} is correctly guessed, the nominal point is 4 points. However, since an answer \textcircled{1} having no similarity to the correct answer is selected, it is assessed that a real point of 3 is awarded by deducting a minus partial point from the nominal point.

For a question No. 24, the answer is correctly guessed, but it takes a time of 5 seconds to solve the question. Therefore, it is assessed that the answer has simply guessed the answer without understanding the question and the question is not normally solved, thereby awarding zero points as opposed to the full 4 points awarded for a correct answer.

On the other hand, in the analysis of the examinee's behavior, abstract information shows a learner's correct answer ratio by input of an answer or input of a corrected answer by changing a selected answer. Thus, there is provided a solution for enhancing the examination result or for obtaining a higher score in an objective examination through analysis of the examinee's behavior.

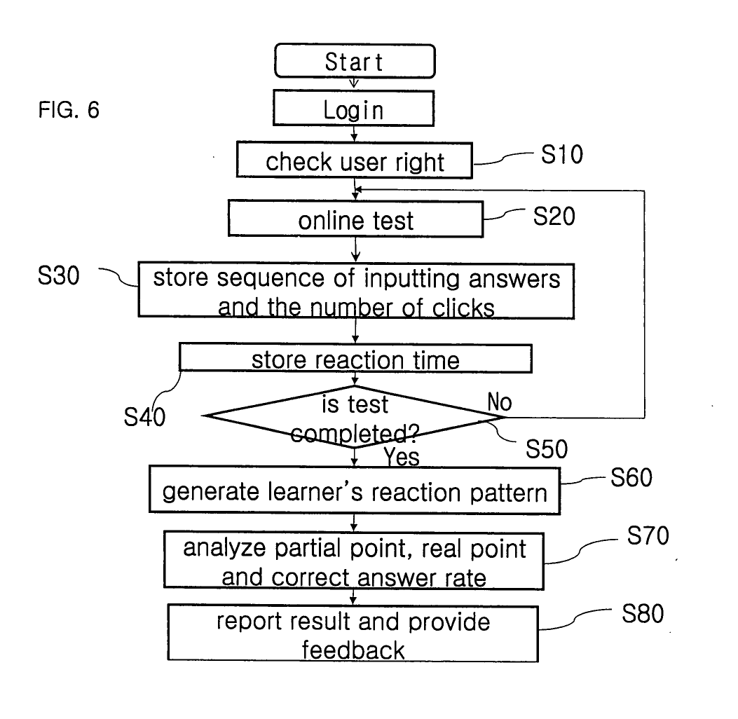

FIG. 6 is a flowchart of a management method for online test assessment according to an embodiment of the present invention.

First, the learner terminal 10 or the teacher terminal 20 accesses the online test assessment management server 100 and validates the learner's login credentials (S10).

Then, the online test assessment management system performs an online test in the learner terminal 10 by outputting a designated examination for the online test (S20).

Here, assessment data regarding a sequence of inputting answers, the number of clicks, and a reaction time are recorded and stored while a learner solves questions output for the online test (S30, S40).

The learner terminal 10 determines whether the online test is finished by completion of selection of answers to all questions as response input to the online test, and generates a reaction pattern from learner's online test assessment data stored based on the online test (S50, S60).

By analyzing the data stored for the online test, the examination behavior is assessed and diagnosed based on a correct answer ratio relating to the selection and change of answers, the real point modified by adding a partial point awarded in consideration of the nominal point, answer selection, answer change and reaction time, and is then electronically reported to the learner terminal or the teacher terminal (S70, S80).

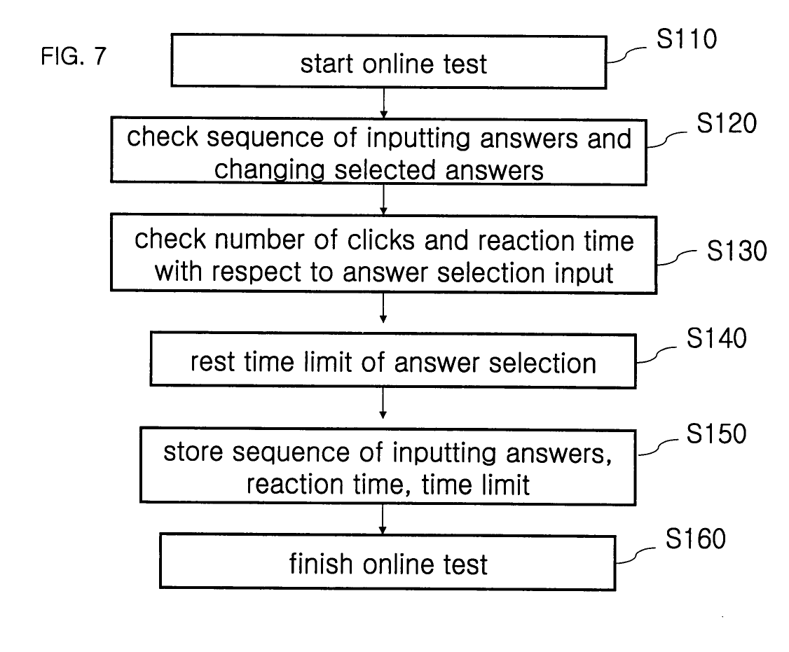

FIG. 7 shows an online test according to questions in the management method for online test assessment according to an embodiment of the present invention.

Referring to FIG. 7, if the online test assessment management system outputs an examination for the online test, the test starts through an interface of the learner terminal 10 (S110).

At this time, the online test assessment management system checks the sequence of inputting answers or changing selected answers by a learner for the questions output for the online test (S120).

Further, the online test assessment management system checks the number of clicks and a reaction time of the learner in response to each input of answers for the questions output for the online test (S130).

In checking the reaction time, the time limit is reset when one question has been answered and the examination proceeds to the next question (S140).

Finally, the sequence of inputting answers, the reaction time and the time limit are stored in connection with the associated questions by mapping them to one another (S150).

Here, the mapping storage is achieved by mapping preset similarities of possible answers to each question.

The online test is finished after storing all of the electronically output test results (S160)

When all of Questions have been Solved or a Predetermined Time Elapses, the Whole online test is finished.

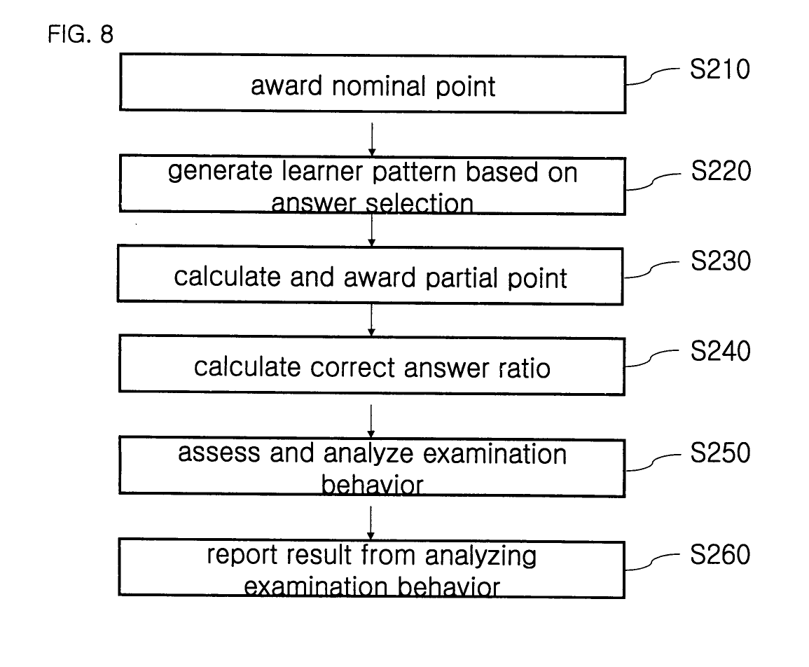

FIG. 8 shows a flowchart of generating, analyzing and reporting a learner's pattern in the management method for online test assessment according to an embodiment of the present invention.

First, a nominal point is awarded by determining whether an answer input response is correct or not with regard to mapping storage data from a learner's online test (S210).

Then, a learner pattern is generated based on the data about the learner's sequence of inputting answers, the number of clicks for changing selected answers, and the reaction time with regard to the questions output for the online test (S220).

The learner pattern is a result obtained by analyzing data about the sequence of inputting answers, the number of clicks and the reaction time with respect to all of the questions, and can be depicted in the form of a table or a graph as shown in Table Sheet B.

Next, a partial point is calculated and awarded in consideration of an added or subtracted point depending on the learner's sequence of inputting answers, the number of clicks for changing selected answers, and the reaction time (S230).

In Table Sheet B, both the partial point and the real point reflecting the partial point are analyzed together with the learner's pattern.

Next, a learner's correct answer ratio by input of an answer or input of a corrected answer by changing a selected answer for each question with respect to the learner's pattern is calculated (S240).

In Table Sheet C, the learner's correct answer ratio by input of an answer or input of a corrected answer by changing a selected answer is provided as abstract information.

Then, examination behavior is assessed and diagnosed based on the correct answer ratio relating to the selection and change of answers, and the real points, which are modified by reflecting the partial point awarded in consideration of the awarded nominal point, the answer selection, the answer change and the reaction time (S250).

Finally, the learner's online test result and examination behavior analysis result are reported for feedback (S260).

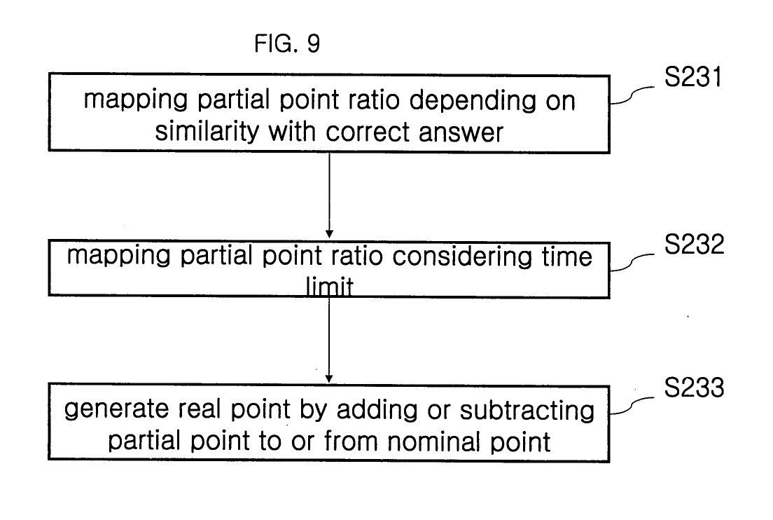

FIG. 9 shows a process of calculating a real point in the management method for online test assessment according to an embodiment of the present invention.

First, a partial point ratio is previously mapped and stored depending on similarity to a correct answer with respect to each of answers in questions output for the online test (S231).

Further, the partial point ratio is previously mapped and stored in consideration of a time limit taken for final selection due to an answer input or answer change with respect to each of answers in the questions output for the online test (S232).

Then, the real point is calculated by adding a plus partial point and a minus partial point to the nominal point according to the partial-point ratio (S233).

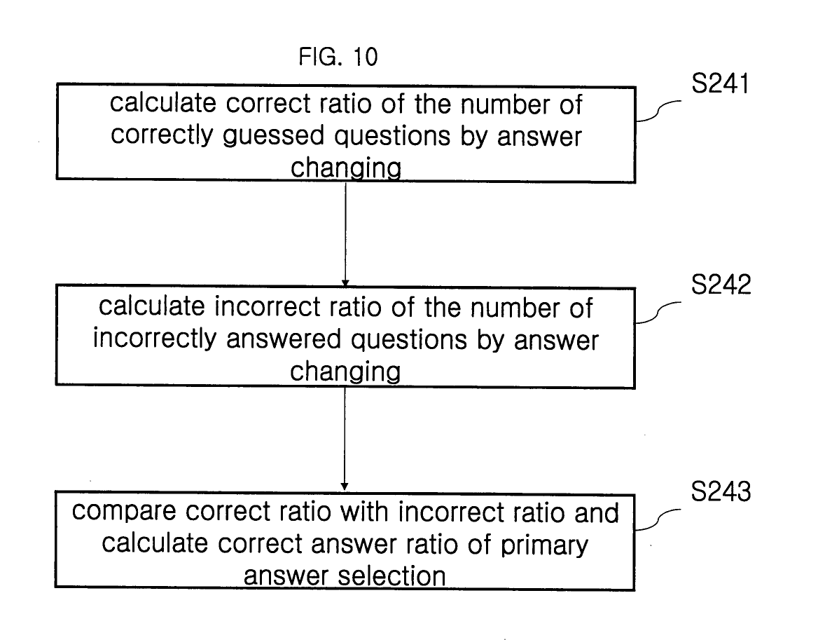

FIG. 10 shows a process of analyzing a correct answer ratio in the management method for online test assessment according to an embodiment of the present invention.

Referring to FIG. 10 together with the embodiment of Table Sheet C, a correct ratio of the number of correctly guessed questions by answer changing to the total number of questions is calculated based on the learner's detailed analysis result (S241).

Further, an incorrect ratio of the number of incorrectly answered questions by changing the answers to the total number of questions is calculated (S242).

Then, the correct answer ratio of the number of correctly guessed questions at primary answer selection to the total number of questions is calculated by comparing the correct answer ratio with the incorrect ratio (S243).

Referring to Table Sheet C, the learner's correct answer ratio based on the input of an answer input or the input of a corrected answer by changing a selected answer is each calculated in the abstract information, and there is provided a guide for enhancing the examination result or obtaining a higher score in an objective examination through the analysis of the examinee's behavior.

As apparent from the above description, the system according to the embodiments of the invention allows a sequence of selecting answers to objective questions, the number of clicks, and a reaction time to be reflected in an assessment result, thereby efficiently assessing and diagnosing learner's understanding of questions and examination skills.

Further, the system according to the embodiments of the invention can enhance learner capacity to solve objective questions by analyzing learner's behavior with respect to an objective examination, and can assess learner's real ability and enhance the learner's ability to solve the questions through calculation of a partial point based on understanding of answers to to a question in addition to an awarded nominal point.

Although the embodiments have been provided to illustrate the invention, it will be apparent to those skilled in the art that the embodiments are awarded by way of illustration only, and that that various modifications, changes, and alterations can be made without departing from the spirit and scope of the invention. Thus, the scope of the invention should be limited only by the accompanying claims and equivalents thereof.

1. An online test assessment management system comprising:
a learner-information database to store login information, personal information, and examination behavior information of a learner;
an item pool database to store questions for an online test and outputting the questions on an online test examination screen during the online test;
an online test unit to perform the online test through the online test examination screen and to collect data about a sequence of inputting answers by the learner with regard to questions output for the online test, the number of clicks for changing selected answers, and a reaction time taken to input an answer after selecting the answer; and
a reaction pattern analysis unit to analyze the data collected by the online test unit, and to assess, diagnose and electronically report learner's learning level, learning ability and examination behavior to a learner or teacher terminal.

2. The system according to claim 1, wherein the online test unit comprises:
an answer input-order check module to check the sequence of inputting answers and the number of clicks for changing selected answers by the learner with regard to the questions output for the online test;
a reaction time check module to check data about the reaction time taken to input the answer after selecting the answer in the online test;
a reset processing module to reset a time limit after one question has been answered and examination proceeds to a subsequent question in checking the reaction time; and
a mapping processing module to map and store the sequence of inputting answers, the reaction time and the time limit with respect to the questions.

3. The system according to claim 1, wherein the reaction pattern analysis unit comprises:
a nominal point module to determine whether an answer selected by the learner is correct or not with respect to a question output for the online test, and to award a nominal point;
a reaction pattern analysis module to analyze data about the sequence of inputting answers, the number of clicks for changing selected answers, and the reaction time of the learner with respect to the questions output for the online test;
a partial point calculation module to calculate and add a partial point awarded in consideration of an additional point or a subtractive point resulting from the learner's change of a selected answer, the number of changing times, and the reaction time with respect to the reaction pattern;
a probability calculation module to calculate a learner's correct answer ratio by input of an answer or input of a corrected answer by changing a selected answer with respect to the reaction pattern; and
a result reporting module to electronically report a learner's examination behavior analysis result based on an assessment result in the reaction pattern to the learner terminal or teacher terminal, the learner's examination behavior analysis result including the correct answer ratio and the partial point according to the learner's answer selection or change.

4. The system according to claim 3, wherein the partial point calculation module comprises:
a similarity mapping module to previously set a partial point ratio depending on a similarity to a correct answer with respect to an answer input or changed by the learner;
a time limit module to set the partial point ratio by setting the time limit taken for final selection corresponding to learner's input or change of an answer; and
a partial point generating module to calculate a plus partial point and a minus partial point to be added to the nominal point based on the partial point ratio estimated by the similarity mapping module and the time limit module.

5. The system according to claim 3, wherein the probability calculation module compares a correct ratio of the number of correctly guessed questions by answer changing to the total number of questions and an incorrect ratio of the number of incorrectly answered questions by changing the answers to the total number of questions with a relative probability of the number of correctly guessed questions without the answer changing.

6. An online test assessment management method comprising:
electronically accessing, by a learner, an online test assessment management system to take an online test;
checking and storing data about a sequence of inputting answers by the learner, the number of clicks for changing selected answers, and a reaction time taken to input selected answers with regard to questions output for the online test; and
analyzing the data stored for the online test, assessing and diagnosing examination behavior of the learner based on a correct answer ratio relating to the selection and change of the answers, a nominal point and a real point, and electronically reporting the examination behavior to a learner or teacher terminal, the real point being modified by adding a partial point awarded in consideration of the nominal point, the answer selection, the answer change, and the reaction time.

7. The method according to claim 6, wherein the step of checking and storing data about a sequence of inputting answers comprises:
checking the sequence of inputting answers or changing selected answer by the learner with regard to the questions output for the online test;
checking the number of clicks and the reaction time of the learner in response to each input of the answers for the questions output for the online test;
resetting a time limit if after one question has been answered and the examination proceeds to a subsequent question in checking the reaction time; and
mapping and storing the sequence of inputting answers, the reaction time and the time limit with respect to the questions, respectively.

8. The method according to claim 6, wherein the step of analyzing the data comprises:
awarding the nominal point by determining whether a learner's answer input response is correct or not with regard to the questions output for the online test;
generating a learner pattern based on the data about the learner's sequence of inputting answers, the number of clicks for changing selected answers, and the reaction time with regard to the questions output for the online test;
calculating and awarding the partial point in consideration of an added or subtracted point depending on the learner's sequence of inputting answers, the number of clicks for changing selected answers, and the reaction time;
calculating the learner's correct answer ratio by input of an answer or input of a corrected answer by changing a selected answer with respect to the learner's pattern;
assessing and diagnosing the examination behavior based on the correct answer ratio relating to the selection and change of the answers, and the real point modified by adding the partial point awarded in consideration of the awarded nominal point, the answer selection, the answer change and the reaction time; and
reporting the learner's online test result and examination behavior analysis result for feedback.

9. The method according to claim 8, wherein the step of calculating and awarding the partial point comprises:
previously mapping and storing a partial point ratio depending on similarity to correct answers with respect to the answers of the questions output for the online test;
previously mapping and storing the partial point ratio in consideration of the time limit taken for final selection corresponding to learner's input or change of the answers with respect to the questions output for the online test; and
calculating the real point by adding a plus partial point and a minus partial point to the nominal point based on the partial point rate.

10. The method according to claim 8, wherein the step of calculating the learner's correct answer ratio comprises:
calculating a correct ratio of the number of correctly guessed questions by answer changing to the total number of questions;
calculating an incorrect ratio of the number of incorrectly answered questions after answer changing to the total number of questions; and
calculating the correct answer ratio of the number of correctly guessed questions at primary answer selection to the total number of questions by comparing the correct ratio with the incorrect ratio.
